(19) United States
(12) Patent Application Publication
(10) Pub. No.: US 2008/0105997 A1
(43) Pub. Date: May 8, 2008

(54) Method for enhancing the sealing potential of formable, disposable tooling materials

(76) Inventors: Michael D. Ridges, American Fork, UT (US); William T. McCarvill, Salt Lake City, UT (US); Dilworth L. Pugh, Mapleton, UT (US)

Correspondence Address: THORPE NORTH & WESTERN, LLP., P.O. Box 1219, SANDY, UT, 84091-1219, US

(21) Appl. No.: 11/975,226

(22) Filed: Oct. 17, 2007

Related U.S. Application Data
(60) Provisional application No. 60/852,570, filed on Oct. 17, 2006.

(51) Int. Cl. B29C 33/38

(52) U.S. Cl. 264/226; 264/219; 425/102

(57) ABSTRACT

Methods for enhancing the sealing potential of a formable, disposable tooling core for use in the fabrication of composite articles, the method comprising obtaining a pre-formed tooling core from a mold, the tooling core having a prepared working surface; applying a liquid prepolymer mixture configured for rapid polymerization at ambient conditions over at least a portion of the working surface; and rapidly polymerizing the prepolymer mixture to form a non-porous sealant over the portion of the working surface. Also, methods for manufacturing tooling members and composite articles utilizing a disposable tooling core.

This application claims the benefit of U.S. Provisional Patent Application No. 60/852,570, filed Oct. 17, 2006, and entitled, “Method For Enhancing The Sealing Potential Of Formable, Disposable,” which is incorporated by reference in its entirety herein.

### FIELD OF THE INVENTION

The present invention relates generally to tooling for use in the fabrication of composite articles, and more particularly to formable, disposable tooling materials or members, as well as to a method for enhancing the sealing potential of such tooling members.

### BACKGROUND OF THE INVENTION AND RELATED ART

Disposable tooling cores, including disposable mandrels, are commonly used to fabricate composite articles having hollow cores or one or more voids. These tooling cores are formed by mixing a filler material with a chemical binder. This formable composition is then packed into a female mold, whereupon pressure and heat is subsequently applied. Once the disposable tooling core is formed, a composite prepreg is laid up on the surface of the tooling core and subjected to known composite forming processes, such as autoclave or vacuum curing. In theory, upon formation of the composite article, the disposable core may be destroyed leaving the composite article.

Although useful, disposable mandrels have significant drawbacks. Perhaps the most significant drawback is the difficulty is sealing the surface of the tooling core. Without a good seal, resin is caused to penetrate the surface and migrate into the interior of the tooling core as these typically comprise a rather porous makeup. If this is permitted to happen, upon curing the composite lay-up supported on the surface of the tooling core, any resin that has migrated into the interior of the tooling core will also cure making it extremely difficult to remove the composite part from the tooling core, despite the advantage of the tooling core being disposable.

One conventional method of sealing disposable tooling cores is to wrap the surface with a Teflon or other similar tape. However, this is very labor intensive and time consuming, thus significantly increasing the cost of the composite articles fabricated.

Another method for sealing comprises applying a liquid coating. However, current formulations are insufficient to provide a true non-porous surface. In addition, current formulations used for such an application require several coats, with each coat requiring a long cure time before the next one can be applied. In addition, these formulations must be cured in a high temperature environment, such as an oven. As such, applying conventional coatings is labor intensive and time consuming.

### SUMMARY OF THE INVENTION

In accordance with the invention as embodied and broadly described herein, the present invention features a method for enhancing the sealing potential of a formable, disposable tooling core for use in the fabrication of composite articles, the method comprising obtaining a pre-formed tooling core from a mold, the tooling core having a prepared working surface; applying a liquid prepolymer mixture configured for rapid polymerization at ambient conditions over at least a portion of the working surface; and rapidly polymerizing the prepolymer mixture to form a non-porous sealant over the portion of the working surface.

The present invention also features a method for manufacturing a formable, disposable tooling member for use in the fabrication of composite articles, the method comprising preparing a formable composition; depositing the formable composition in a cavity of a mold; curing the formable composition within the cavity to form a tooling core having a working surface; removing the tooling core from the mold cavity; and sealing the tooling core with a non-porous sealant comprising a liquid prepolymer mixture configured for rapid polymerization at ambient conditions, the sealant and the tooling core combining to form the tooling member.

The present invention further features a method for manufacturing a composite article from a disposable tooling member, the method comprising obtaining a pre-formed, disposable tooling core having a working surface; applying a liquid prepolymer mixture configured for rapid polymerization at ambient conditions to at least a portion of the working surface; rapidly polymerizing the prepolymer mixture to form a non-porous sealant over the working surface; laying up a composite prepreg over the sealant and about the working surface of the tooling core to form the tooling member; forming a composite article about the tooling member from the composite prepreg; destroying the tooling core once the composite article is formed; and removing the sealant from the composite article once the tooling core is destroyed.

The present invention still further features a method for manufacturing a disposable tooling member for use in the fabrication of composite articles, the method comprising obtaining a mold having a cavity formed therein; preparing a formable composition; applying a liquid prepolymer mixture configured for rapid polymerization at ambient conditions to at least a portion of the cavity of the mold; rapidly polymerizing the prepolymer mixture to form a non-porous sealant; depositing the formable composition in the cavity of the mold over the sealant; curing the formable composition within the cavity to form a tooling core having a working surface, the sealant and the tooling core forming a tooling member; and removing the tooling member from the mold cavity, the sealant being disposed over the working surface of the tooling core.

The present invention still further features a method for manufacturing a composite article from a disposable tooling member, the method comprising obtaining a mold having a cavity formed therein; preparing a formable composition; applying a liquid prepolymer mixture configured for rapid polymerization at ambient conditions to at least a portion of the cavity of the mold; rapidly polymerizing the prepolymer mixture to form a non-porous sealant; depositing the formable composition in the cavity of the mold over the sealant; curing the formable composition within the cavity to form a tooling core having a working surface, the sealant and the tooling core forming a tooling member; removing the tooling member from the mold cavity, the sealant being disposed over the working surface of the tooling core; laying up a composite prepreg over the sealant and the tooling member; forming a composite article about the tooling member from the composite prepreg; destroying the tooling core once the composite article is formed; and removing the sealant from the composite article once the tooling core is destroyed.

The present invention still further features a method for manufacturing a disposable tooling member for use in a bladder molding process for the fabrication of composite articles, the method comprising obtaining a mold having an inner working surface formed thereon; obtaining a spacer conforming to and providing a scaled inner surface corresponding to the inner working surface of the mold; applying a liquid prepolymer mixture configured for rapid polymerization at ambient conditions to at least a portion of the scaled inner surface of the spacer; rapidly polymerizing the prepolymer mixture to form a sealant configured to function as a bladder; preparing a formable composition; depositing the formable composition on an inner surface of the bladder; and curing the formable composition to form a disposable core, the disposable core and the bladder making up the disposable tooling member.

The present invention still further features a method for manufacturing a composite article in accordance with the steps of the immediately preceding method, further comprising separating the tooling member from the spacer to expose an outer surface of the bladder; laying up a composite prepreg about the tooling member and over the outer surface of the bladder; inserting the tooling member, with the composite lay-up, into the mold; and forming the composite part by pressurizing the bladder to force the composite prepreg against the inner working surface of the mold.

The present invention still further features a tooling member for use in the fabrication of composite articles, the tooling member comprising a formed, disposable core made from a formable composition; and a pliable sealant adjacent the formed, disposable core, the sealant being formed from a liquid prepolymer mixture configured for rapid polymerization at ambient conditions.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a flow diagram of a method for enhancing the sealing potential of a pre-formed tooling core in accordance with one exemplary embodiment of the present invention;

FIG. 2 illustrates a flow diagram of a method for manufacturing a formable, disposable tooling member for use in the fabrication of composite articles in accordance with one exemplary embodiment of the present invention;

FIG. 3 illustrates a flow diagram of a method for manufacturing a composite article from a disposable tooling member in accordance with one exemplary embodiment of the present invention;

FIG. 4 illustrates a flow diagram of a method for manufacturing a disposable tooling member for use in the fabrication of composite articles in accordance with another exemplary embodiment of the present invention;

FIG. 5 illustrates a flow diagram of a method for manufacturing a composite article from a disposable tooling member in accordance with another exemplary embodiment of the present invention;

FIG. 6 illustrates a flow diagram of a method for manufacturing a disposable tooling member in accordance with another exemplary embodiment of the present invention; and

FIG. 7 illustrates a flow diagram of a method for manufacturing a composite article from a disposable tooling member in accordance with another exemplary embodiment of the present invention.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

Generally speaking, the present invention describes a method and system for enhancing the sealing potential of disposable tooling materials, namely disposable tooling members, such as disposable tooling cores or mandrels, used to fabricate hollow composite articles, or composite articles comprising a void, such as stringers, water or air ducts, water tanks, wheels, etc. The present invention also describes a method for manufacturing a disposable tooling member, and a method for manufacturing a composite article from a formed disposable tooling member. The present invention contemplates disposable tooling cores of various types, such as those used in mandrel core processes where pressure is applied from without the tooling member forcing the composite materials against the core, or bladder molding processes where pressure is applied from within the tooling member forcing the composite against an outer shell or mold.

In accordance with the present invention, it is contemplated to provide a tooling member comprised of a disposable core and a sealant disposed about the core. The sealant and disposable core components of the tooling member may be formed at different times and in different order with respect to one another. For example, the disposable core may be formed first (a pre-formed disposable core), wherein the sealant is applied thereafter. In another example, the sealant may be formed first, with the disposable core formed about the sealant (a post-formed disposable core).

The sealant, which may provide a dual function as a bladder in some embodiments, comprises a fast setting, fast curing composition that is some cases may be sprayable. For example, the composition may comprise a polyurea-based prepolymer mixture, made by combining an isocyanate component with a resin blend component. One particular type of polymers that may be used are those produced by Engineered Polymers International, LLC of Madison, Wis., and that are marketed as comprising Reactamine® technology. The prepolymer mixture forms a coating that rapidly polymerizes at ambient conditions into a flexible, non-porous seal having a shape conforming to the contoured surface to which it is applied (e.g., the surface of the open mold or the surface of the disposable core depending upon the stage of the process in which the sealant is applied), and that holds pressure. The composition may also comprise a silicone. In any event, once applied, the sealant functions to provide a non-porous seal about the disposable core that reduces the potential for resin migration.

The sealant of the present invention overcomes the limitations currently existing in the art as it is easily applied manually or with a spray device, sets up, cures or rapidly polymerizes, and provides an airtight, non-porous seal.

As used herein, the term “disposable tooling core” or “disposable core” or “tooling core” shall be understood to mean any type of tooling core capable of being formed into a desired geometric configuration, and comprising a composition that is disposable, or that is capable of being destroyed once the composite article is fabricated. Disposable tooling cores are intended to comprise various types known in the art, such as water-soluble tooling cores or mandrels, as well as those types of tooling cores used in bladder molding processes, such as urethane foam compositions.

The term “tooling member,” as used herein, shall be understood to mean the combination of a disposable tooling core and a sealant positioned adjacent a working surface of the tooling core. Depending upon the type of composite fabricating system being used, the sealant may be applied to an outer working surface of a pre-formed tooling core, or a disposable composition used to form a tooling core may be applied to the inner surface of a sealant applied over a surface.

The term “working surface,” as used herein, shall be understood to mean all or part of a surface of a tooling member configured to receive a composite lay-up for the fabrication of a composite article.

The term “ambient,” as used herein, shall be understood to mean conditions of non-elevated temperatures, namely between 60° and 80° F., and non-elevated pressures, namely atmospheric.

The term “rapid polymerization,” as used herein, shall be understood to mean the polymerization of the prepolymer within a time period less than five minutes. In some embodiments, polymerization may occur within seconds (e.g., one to thirty seconds, and preferably three to fifteen seconds) after being mixed and applied, while in other embodiments, polymerization may take place in minutes (e.g., one to five minutes, and preferably less than three minutes).

Pre-Formed Mandrel-Type Disposable Core

The present invention contemplates methods and systems for sealing pre-formed disposable tooling cores (cores that are formed, cured or dried and finished), such as mandrels, wherein a sealant is applied to the outer surface of the disposable tooling core to enhance the sealing potential of the disposable tooling core, and thus prevent migration of resins into the material of the disposable tooling core during manufacture of a composite article. As such, various unique methods of forming tooling members having a sealant are presented and set forth.

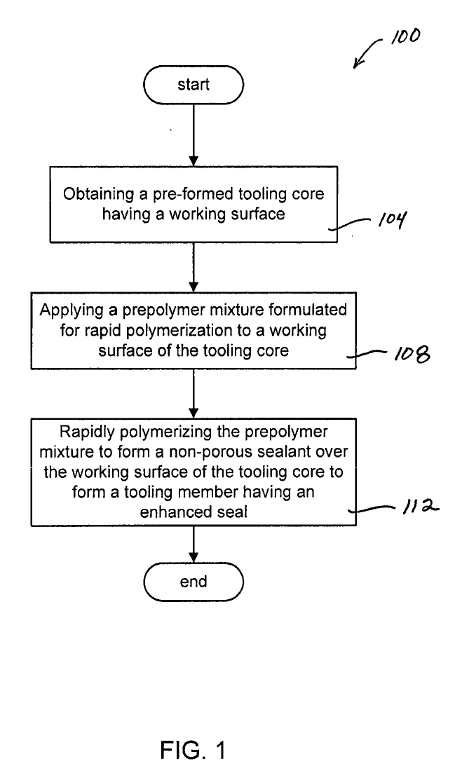

With reference to FIG. 1, illustrated is a flow diagram of a method for enhancing the sealing potential of a pre-formed disposable tooling core in accordance with one exemplary embodiment of the present invention. As shown, the method 100 comprises step 104, obtaining a pre-formed disposable tooling core having a working surface; step 108, applying a prepolymer mixture formulated or configured for rapid polymerization to a working surface of the tooling core; and step 112, rapidly polymerizing the prepolymer mixture to form a non-porous sealant over the working surface of the tooling core to form a tooling member having an enhanced seal. As formed this way, the working surface now includes the sealant.

The pre-formed disposable tooling core may comprise any type and configuration known in the art. In one aspect, the disposable tooling core may comprise a water-soluble tooling core, sometimes referred to as a water-soluble mandrel. Exemplary types and compositions of water-soluble tooling cores or mandrels, as well as methods for removing such tooling cores from composite articles, are set forth in U.S. Pat. No. 6,828,373 to Artz et al.; U.S. Publication No. 2002/0173575 to Artz et al.; U.S. Publication No. 2004/0195713 to Hansel; and U.S. Publication No. 2005/0116136 to Artz et al., each of which are incorporated by reference herein. Other types of disposable tooling cores include those made from eutectic salt, sodium silicate-bonded sand, and poly (vinyl alcohol) bonded ceramic microspheres.

The working surface of the tooling core may comprise all or a portion of an outside surface of the disposable tooling core, as well as the sealant. The working surface is intended to support a composite lay-up, such as a prepreg.

The prepolymer mixture may be made from any component or group of components which combine to form a non-porous sealant that rapidly polymerizes about a surface to which it is applied. Depending upon the composition of the prepolymer, polymerization preferably takes place within three minutes (or even within five to ten seconds or less). In addition, polymerization is intended to occur at ambient conditions, as defined herein. Rapid polymerization at ambient conditions provides significant advantages over prior related sealants in that time and labor are both significantly reduced, thus significantly reducing manufacturing costs. In addition, rapid polymerization simplifies many of the process steps typically required in the fabrication of composite articles.

In one exemplary embodiment, the prepolymer mixture comprises a polyurea-based resin made by combining an isocyanate component with a resin blend component. In one aspect, these two components may be mixed in a spray device and dispensed therefrom, or in another type of mixing and dispensing device. The isocyanate component may be further broken down into an isocyanate building block, such as an MDI monomer, connected to a flexible link with a urethane bond. In the preferred embodiment above, the isocyanate building block may have reactive end groups selected from a group consisting of polyol or amine, and the flexible link can be selected from a group consisting of polyether, silicone, polybutadiene or other low ‘Tg’ segments. The resin blend component may comprise an amine-terminated polymer resin.

To enable rapid polymerization, the isocyanate component, or “A side,” is mixed with a resin blend, or “B side” component, which in one embodiment, as discussed above, comprises an amine-terminated polymer resin. When mixed together, the two A and B side components combine by way of a urea bond to form a long, polyurea-based molecule, which then cross-links with other similar molecules to form the sealant of the present invention.

In another exemplary embodiment, the prepolymer mixture may comprises a sprayable silicone or a silicone-modified polyurea. The sprayable silicone prepolymer, like the polyurea-based prepolymer, may be formulated and configured to rapidly polymerize at ambient conditions.

As indicated, the present invention contemplates many different types or variations of the prepolymer composition. For purposes of discussion, an exemplary first specific type of polyurea-based prepolymer composition comprises a two part polyurea, namely an “A” side polymeric MDI comprised of diphenylmethane-diisocyanate (MDI), and modified MDI; and a “B” side polymeric polyol comprised of aliphatic amines (polyoxypropylene diamine), di-ethyl toluene diamine (DETDA). The “A” side is present in an amount by weight between 25 and 40 percent, and preferably between 30 and 35 percent. The “B” side is present in an amount by weight between 60 and 75 percent, and preferably between 65 and 70 percent. This composition is available under the several products being marketed as Reactamine®, or as comprising Reactamine® technology.

An exemplary second specific type of polyurea-based prepolymer composition comprises a two part polyurea, namely an “A” side aromatic isocyanate comprised of polyurethane prepolymer, diphenylmethane-diisocyanate (MDI), and alkylene carbonate; and a “B” side aromatic polyurea comprised of polyoxyalkyleneamine, diethyltoluenediamine (DETDA), and polyoxyalkyleneamine carbon black. The “A” side is present in an amount by weight between 40 and 60 percent, and preferably between 45 and 55 percent. The “B” side is present in an amount by weight between 40 and 60 percent, and preferably between 45 and 55 percent. This composition is available from Bay Systems North America.

It is noted that these two compositions are not meant to be limiting in any way. Indeed, those skilled in the art may realize other compositions that may be used to practice the invention as taught and described herein.

Although various compositions are contemplated, the prepolymer mixture is intended to be engineered in a manner so as to provide a sealant having one or more of the following desirable characteristics—formed from a quick setting, quick curing prepolymer (rapid polymerization), having a non-porous surface, able to withstand temperatures between 200° and 500° F., and preferably above 350° F., pliable, and able to release and be easily removed from the fabricated composite article once the disposable tooling core is destroyed.

As the prepolymer mixture is applied to the surface of the disposable tooling core it adheres to the surface of the disposable tooling core. Upon polymerization, the sealant is formed, which comprises a non-porous layer or surface that functions to seal the disposable tooling core. The sealant and the disposable tooling core combine to form a complete ready-to-use tooling member. The primary function of the sealant is to prevent migration of resin into the tooling core during the forming and curing of the composite lay-up supported about the tooling member. As stated above, if resin is allowed to migrate into the tooling core, and once the composite lay-up and resin are cured, the tooling core will be extremely difficult to completely destroy (thus separate from the finished composite article) and additional manufacturing steps may be required to create a finished composite article. As such, an impermeable, non-porous layer is desirable.

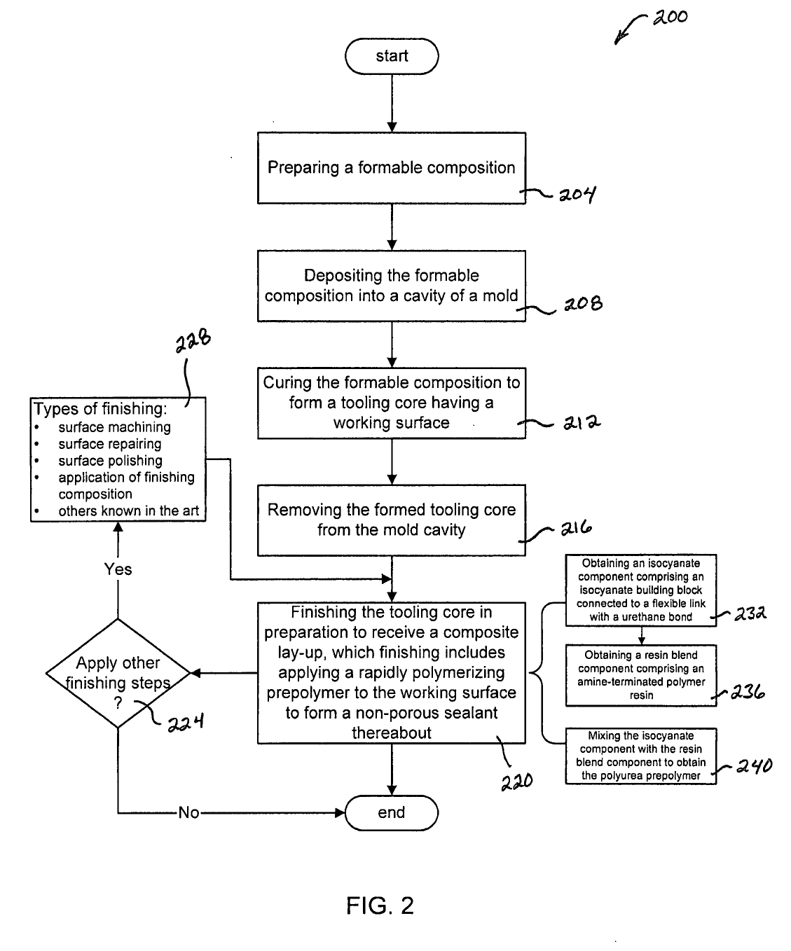

With reference to FIG. 2, illustrated is a flow diagram of a method for manufacturing a formable, disposable tooling member for use in the fabrication of composite articles in accordance with one exemplary embodiment of the present invention. As shown, the method 200 comprises step 204, preparing a formable composition; step 208, depositing the formable composition into a cavity of a mold; step 212, curing the formable composition within the cavity to form a disposable tooling core having a working surface; step 216, removing the formed disposable tooling core from the mold cavity; and step 220, sealing the disposable tooling core with a non-porous sealant comprising a liquid prepolymer mixture configured for rapid polymerization at ambient conditions.

The steps undertaken to fabricate or form a disposable tooling core, namely steps 204, 208, 212, 216, 220, and 228 are well known in the art and are not described in detail herein. Suffice it to say, any known method of forming a disposable tooling core is intended to be within the scope of the present invention.

As illustrated in steps 232, 236, and 240, sealing may be achieved by obtaining an isocyanate component comprising an isocyanate building block connected to a flexible link with a urethane bond, obtaining a resin blend component comprising an amine-terminated polymer resin, and mixing the isocyanate component with the resin blend component to obtain a polyurea prepolymer mixture, which can be applied to the tooling core. In another aspect, the sealing may be achieved by obtaining and applying to the tooling core a sprayable silicone.

The method 200 may further comprise, prior to sealing, determining whether the tooling core is to undergo one or more finishing process (see step 224). Several exemplary finishing steps are illustrated in step 228, such as surface machining, surface repairing, surface polishing, and/or applying a finishing composition. These and others are well known in the art.

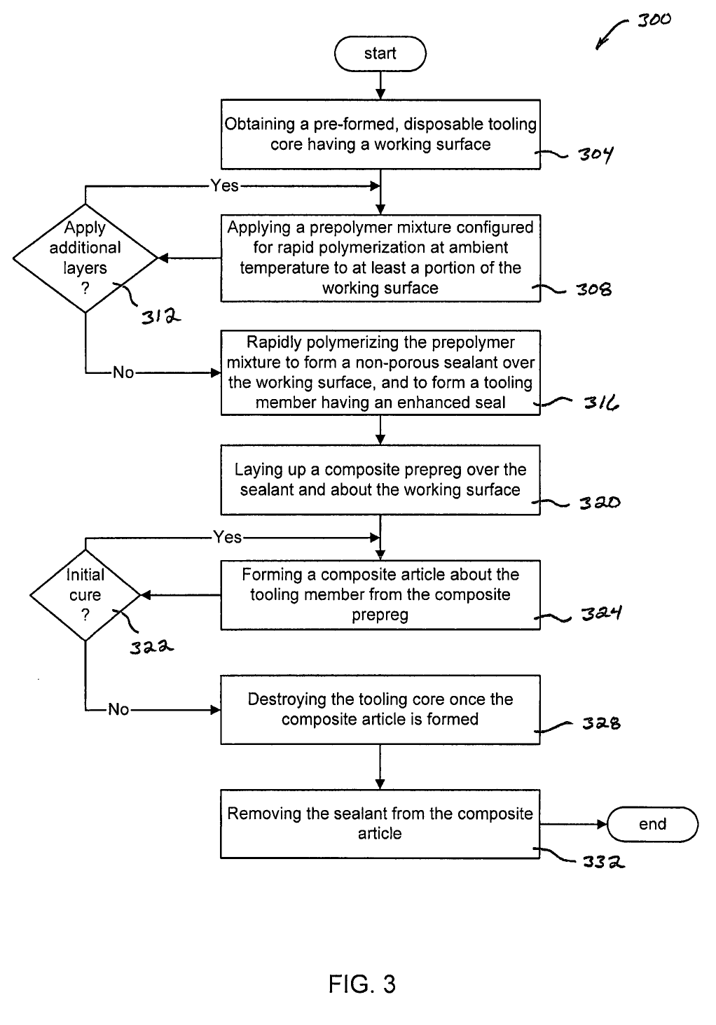

With reference to FIG. 3, illustrated is a flow diagram of a method for manufacturing a composite article from a disposable tooling member in accordance with another exemplary embodiment of the present invention. As shown, the method 300 comprises step 304, obtaining a pre-formed, disposable tooling core having a working surface; step 308, applying a prepolymer mixture configured for rapid polymerization at ambient conditions to at least a portion of the working surface; step 316, rapidly polymerizing the prepolymer mixture to form a non-porous sealant over the working surface; step 320, laying up a composite prepreg over the sealant and about the working surface of the tooling core to form a tooling member; step 324, forming a composite article about the tooling member from the composite prepreg; step 328, destroying the tooling core once the composite article is formed and the sealing components removed; and step 332, removing the sealant from the composite article once the tooling core is destroyed.

As indicated in step 312, a plurality of layers or coats of the prepolymer mixture may be applied to the tooling core in order to obtain as thick a seal as desired, or to build-up the tooling core. Each successive layer is preferably applied prior to the previous layer being completely set up or cured, but this is not necessary.

The step 324 of forming a composite article may further comprise sealing the composite prepreg with a vacuum bag or upper tool enclosure, as commonly known in the art, and curing the composite prepreg to form the composite article. Forming may further include a debulking process.

Once the composite article is formed, and the various sealing components removed, the tooling core remains inside the composite article. As such, the tooling core may be destroyed using known methods to breakup the tooling core and cause it to separate from the composite article. The sealant, providing a non-porous surface and barrier that prevents resin migration, facilitates this process since all resin is contained (e.g., little or no migration into the disposable tooling core). Once the tooling core has been removed, the remaining pliable sealant may be peeled away from the surface of the composite article. As such, it is contemplated that the sealant may be applied over a release agent as well.

As indicated in step 322, the method 300 may further comprise subjecting the tooling member and the sealed composite lay-up to an initial cure for the purpose of reducing the potential for breakdown of the sealant, and for maintaining pliability of the sealant to permit easy and efficient peeling away from the composite article once formed. The initial cure preferably takes place after the lay-up is completed and sealed, but prior to the curing of the composite lay-up. The initial cure may take place at an elevated temperature ranging between 200° and 500° F., and for a duration of time between five and three-hundred minutes, but preferably between fifteen and sixty minutes.

Post-Formed Mandrel-Type Disposable Tooling Core

The present invention also contemplates methods and systems for sealing disposable tooling cores, in which the disposable tooling core is formed or fabricated after the formation of the sealant. In this aspect, a formable composition used to fabricate the tooling core is applied to a surface of a pre-formed sealant, preferably within a mold cavity. As such, various additional unique methods of forming tooling members are presented and set forth.

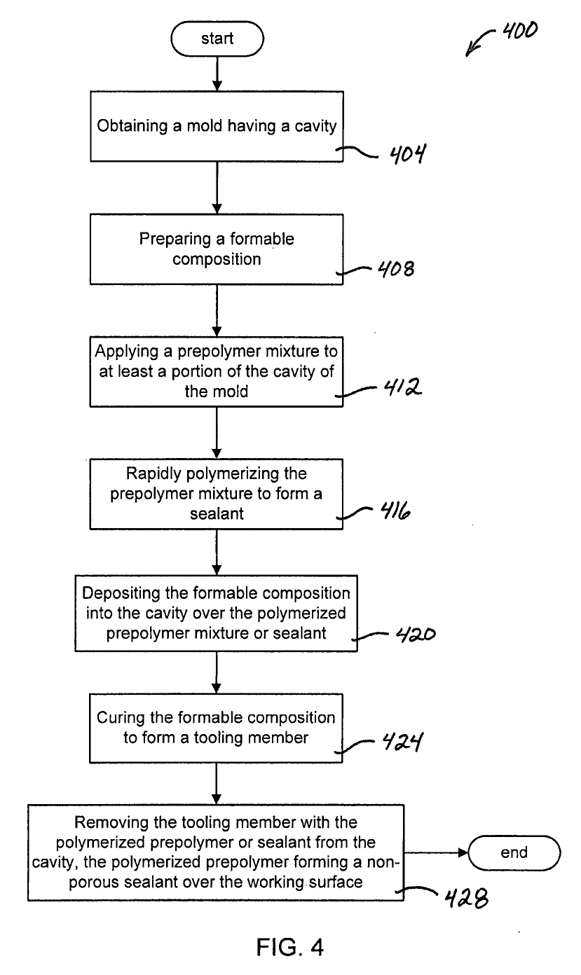

With reference to FIG. 4, illustrated is a flow diagram of a method for manufacturing a disposable tooling member for use in the fabrication of composite articles in accordance with another exemplary embodiment of the present invention. As shown, the method 400 comprises step 404, obtaining a mold having a cavity formed therein; step 408, preparing a formable composition similar to those discussed above; step 412, applying a liquid prepolymer mixture configured similar to those discussed above to at least a portion of the cavity of the mold; step 416, rapidly polymerizing the prepolymer mixture to form a non-porous sealant; step 420, depositing the formable composition in the cavity of the mold over the sealant; step 424, curing the formable composition within the cavity to form a tooling core having a working surface, wherein the sealant and the tooling core combine to form the tooling member, in a similar manner as set forth and discussed above; and step 428, removing the tooling member from the mold cavity, wherein the sealant is disposed over the working surface of the tooling core.

The open mold comprises a mold cavity having any one of a variety of configurations depending upon the desired composite article to be manufactured. Indeed, the mold cavity may comprise various flat, recessed, or protruding surface portions, or any combination of these, within the overall cavity. In other words, the prepolymer mixture may be applied over the surface of a mold cavity having any contour due to the rapid polymerization of the prepolymer mixture and its ability to take on a solidified form shortly after being applied to the surface. While not a requirement, the mold cavity may be prepared prior to applying the prepolymer mixture onto the cavity surface. This preparation may consist of simply applying a release layer to ensure that the sealant readily releases from the open mold after polymerization without tearing or ripping, therefore maintaining its structural integrity.

According to the present exemplary embodiment, after polymerization is complete the sealant and formed tooling member can be removed from the cavity of the open mold and later used in an RTM autoclave or other vacuum bagging process for the fabrication of the fiber-reinforced composite article. As polymerization takes place in a matter of seconds, the lengthiest process in forming the composite article is the actual RTM or vacuum bagging process. Indeed, unlike prior related sealants that require a long cure time and at elevated temperatures, thus increasing the overall time to fabricate the composite article, the time required to seal the tooling member is significantly reduced, thus significantly reducing the overall time needed to fabricate the composite article. After polymerization, which again occurs within seconds, the sealant is ready to receive the composite lay-up. As such, the lengthiest time constraint for this part of the process is the proper and complete setup of the tooling member. In addition, the sealant is not affected by the high temperatures used to cure the formable composition since the sealant is designed to withstand such high temperatures, as will be experienced during the curing of the composite lay-up.

In this method, the prepolymer mixture is allowed to polymerize to form the sealant prior to receiving the formable composition, thus the sealant is pre-formed. The pre-formed sealant is also the layer or portion of the tooling member formed directly on the surface of the mold cavity. This may be advantageous over the method utilizing a pre-formed disposable tooling core as described above for one or more reasons. For example, by forming the sealant on the mold cavity first, followed by the depositing and formation of the tooling core thereafter, the resulting tooling member is able to facilitate much higher tolerances being achieved within the fabricated composite article. Indeed, the size of the tooling member is able to correspond exactly, or within a negligible amount, to the size of the mold cavity. Second, the sealant is able to set and take the exact surface finish of the mold cavity, including small radii, exact dimensions, etc. Thus, thickness of sealant is not an issue because the rest of the volume of the mold cavity can be filled with the formable composition.

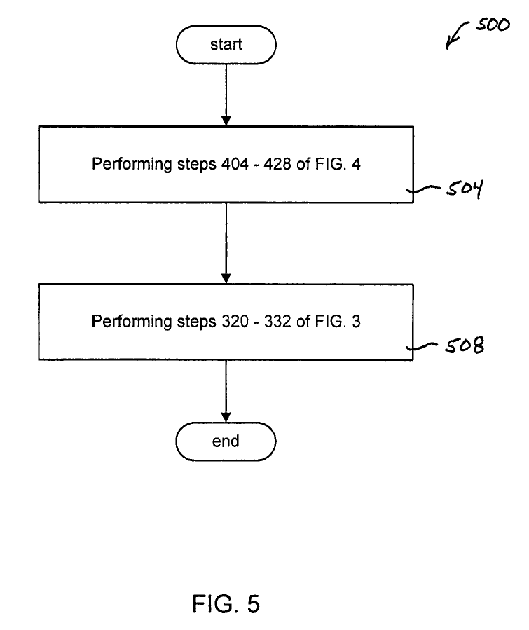

With reference to FIG. 5, illustrated is a flow diagram of a method for manufacturing a composite article from a disposable tooling member in accordance with another exemplary embodiment of the present invention. As shown, the method 500 comprises step 504, which comprises performing the steps 404-428 discussed above and illustrated in FIG. 4; and step 508, which comprises performing the steps 320-332 discussed above and illustrated in FIG. 3.

Tooling Core for Use in Bladder Molding Process

The present invention still further contemplates formation of a sealant that functions as a bladder within a bladder molding process. The tooling member in this aspect is formed in a similar manner as the post-formed mandrel-type disposable tooling core.

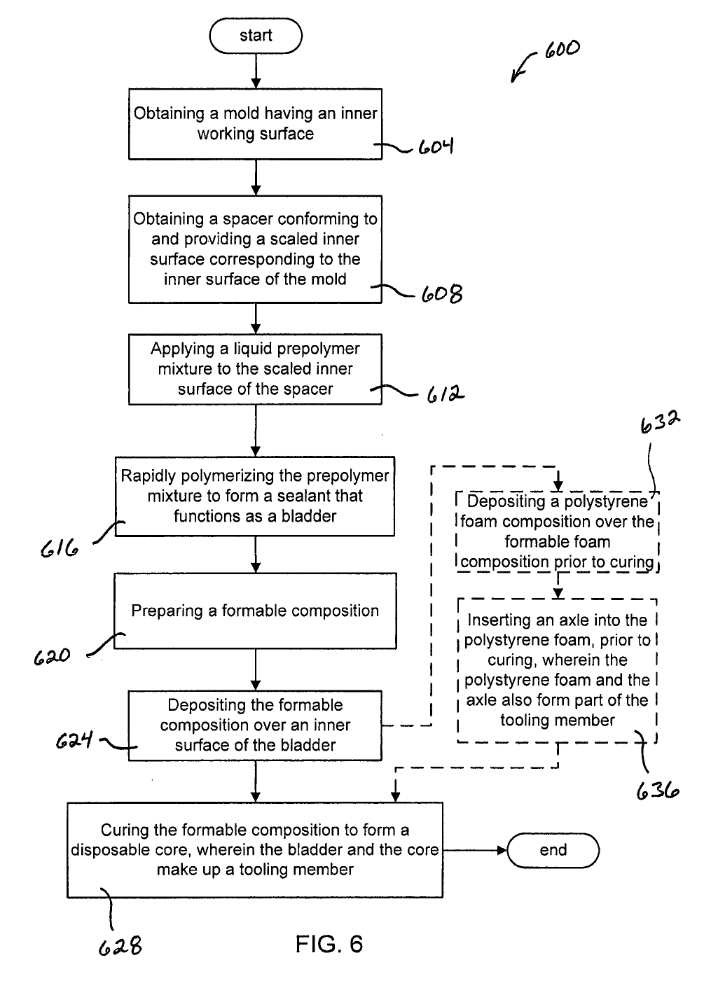

With reference to FIG. 6, illustrated is a flow diagram of a method for manufacturing a disposable tooling member in accordance with another exemplary embodiment of the present invention. As shown, the method 600 comprises step 604, obtaining a mold having an inner working surface formed thereon; step 608, obtaining a spacer conforming to and providing a scaled inner surface corresponding to the inner working surface of the mold; step 612, applying a liquid prepolymer mixture configured for rapid polymerization at ambient conditions to at least a portion of the scaled inner surface of the spacer; step 616, rapidly polymerizing the prepolymer mixture to form a sealant configured to function as a bladder; step 620, preparing a formable composition; step 624, depositing the formable composition on an inner surface of the bladder; and step 628, curing the formable composition to form a disposable core, wherein the disposable core and the bladder combine to make up a disposable tooling member.

The mold may comprise various types of molds, such as an outer mold line or OML used in the fabrication of airplane fuselages. Other types of molds are known and contemplated herein.

The formable composition may comprise various types known in the art. In one aspect the formable composition comprises a urethane foam. The formable composition, as part of the tooling member, is also intended to provide a caul-like function once the composite lay-up is supported about the tooling member, inserted into the mold, and the system pressurized.

The method 600 further comprises step 632, depositing a polystyrene foam composition about the formable composition; and step 636, inserting an axle within the polystyrene foam. Inclusion of a polystyrene foam and an axle within a bladder molding system are known in the art. Each of these steps may be subsequently carried out which permit the polystyrene foam and the axle to be a part of the tooling member.

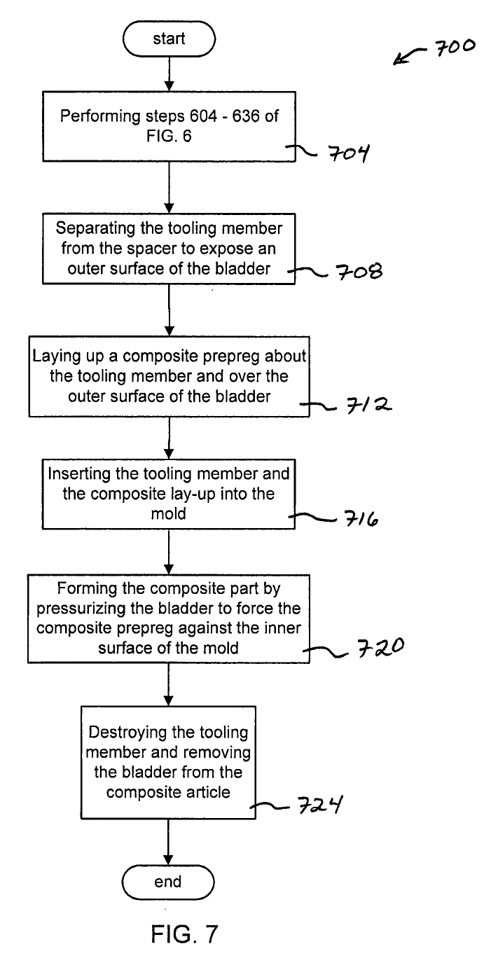

With reference to FIG. 7, illustrated is a flow diagram of a method for manufacturing a composite article from a disposable tooling member in accordance with another exemplary embodiment of the present invention. As shown, the method 700 comprises step 704, performing the steps 604-636 discussed above and shown in FIG. 6; and further comprising step 708, separating the tooling member from the spacer to expose an outer surface of the bladder; step 712, laying up a composite prepreg about the tooling member and over the outer surface of the bladder; step 716, inserting the tooling member, with the composite lay-up supported thereon, into the mold; and step 720, forming the composite part by pressurizing the bladder to force the composite prepreg against the inner working surface of the mold.

Once the composite article is formed, the tooling member may be destroyed. More particularly, the axle may be removed and the various foam layers making up the core destroyed using known techniques. Once the foam layers are destroyed, the bladder may be peeled away from the composite article in a similar manner as taught above.

It is noted that the bladder may comprise any of the compositions discussed above, and that the function of the bladder is similar to those described above, namely to provide a sealant to prevent the migration of resin into the tooling core. In addition, it is also contemplated that the sealant and the sealant functioning as a bladder may comprise a textured surface formed by applying the prepolymer to a textured surface, such as a textured mold or spacer surface. Texturing the sealant will facilitate airflow across its surface, much like a breather.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed and desired to be secured by Letters Patent is:

1. A method for enhancing the sealing potential of a formable, disposable tooling core for use in the fabrication of composite articles, said method comprising:
obtaining a pre-formed disposable tooling core from a mold, said disposable tooling core having a prepared working surface;
applying a liquid prepolymer mixture configured for rapid polymerization at ambient conditions over at least a portion of said working surface; and
rapidly polymerizing said prepolymer mixture to form a non-porous sealant over said portion of said working surface to prevent resin migration into said disposable tooling core during manufacture of a composite article.

2. The method of claim 1, wherein said pre-formed tooling core comprises a water-soluble mandrel.

3. The method of claim 1, wherein said prepolymer mixture is a polyurea-based resin made from mixing an isocyanate component and a resin blend component.

4. The method of claim 3, wherein said isocyanate component further comprises an isocyanate building block connected to a flexible link with a urethane bond.

5. The method of claim 4, wherein said isocyanate building block is an MDI monomer.

6. The method of claim 4, wherein said flexible link is selected from a group consisting of polyether, silicone, and polybutadiene.

7. The method of claim 3, wherein said resin blend component further comprises an amine-terminated polymer resin.

8. The method of claim 1, wherein said prepolymer mixture comprises, at least in part, a sprayable silicone.

9. The method of claim 1, wherein said obtaining comprises:
preparing a formable composition;
depositing said formable composition in a cavity of a mold;
curing said formable composition within said cavity to form said tooling core having a partially finished surface;
removing said tooling core from said mold cavity; and
finishing said surface of said tooling core.

10. The method of claim 1, wherein said applying comprises spraying said polyurea prepolymer mixture from a mixing gun.

11. A method for manufacturing a formable, disposable tooling member for use in the fabrication of composite articles, said method comprising:
preparing a formable composition;
depositing said formable composition in a cavity of a mold;
curing said formable composition within said cavity to form a tooling core having a working surface;
removing said tooling core from said mold cavity; and
sealing said tooling core with a non-porous sealant comprising a liquid prepolymer mixture configured for rapid polymerization at ambient conditions to prevent resin migration into said disposable tooling core during manufacture of a composite article, said sealant and said tooling core combining to form said tooling member.

12. The method of claim 11, wherein said sealing further comprises:
obtaining an isocyanate component comprising an isocyanate building block connected to a flexible link with a urethane bond;
obtaining a resin blend component comprising an amine-terminated polymer resin;
mixing said isocyanate component with said resin blend component to obtain said polyurea prepolymer mixture;
applying said polyurea prepolymer mixture, in liquid form, over said working surface of said tooling core;
rapidly polymerizing said polyurea prepolymer mixture about said working surface.

13. The method of claim 12, wherein said isocyanate building block comprises an MDI monomer.

14. The method of claim 12, wherein said flexible link is selected from the group consisting of a polyether, a silicone, and a polybutadiene.

15. The method of claim 11, further comprising finishing said surface of said tooling member.

16. The method of claim 11, wherein said prepolymer mixture comprises, at least in part, a sprayable silicone.

17. A method for manufacturing a composite article from a disposable tooling member, said method comprising:
obtaining a pre-formed, disposable tooling core having a working surface;
applying a liquid prepolymer mixture configured for rapid polymerization at ambient conditions to at least a portion of said working surface;
rapidly polymerizing said prepolymer mixture to form a non-porous sealant over said working surface to prevent resin migration into said disposable tooling core during manufacture of a composite article;
laying up a composite prepreg over said sealant and about said working surface of said tooling core to form said tooling member;
forming a composite article about said tooling member from said composite prepreg;
destroying said tooling core once said composite article is formed; and
removing said sealant from said composite article once said tooling core is destroyed.

18. The method of claim 17, wherein said step of forming comprises:
sealing said composite prepreg;
applying a resin to said composite prepreg; and
curing said composite prepreg and said resin to form said composite article.

19. The method of claim 18, wherein said sealing said composite prepreg is carried out using a vacuum bag over said composite prepreg.

20. The method of claim 18, wherein said sealing said composite prepreg is carried out using an upper tool enclosure over said composite prepreg.

21. The method of claim 17, further comprising curing, initially, said tooling member after said laying up of said composite prepreg, and prior to said forming said composite article, said curing reducing the potential for breakdown and maintaining pliability of said sealant to permit peeling away from said composite article once formed.

22. The method of claim 21, wherein said initial curing takes place at an elevated temperature ranging between 200° and 400° F., for a duration of time between 5 and 60 minutes.

23. The method of claim 17, wherein said removing comprises peeling away said sealant from said composite article.

24. A method for manufacturing a disposable tooling member for use in the fabrication of composite articles, said method comprising:
obtaining a mold having a cavity formed therein;
preparing a formable composition;
applying a liquid prepolymer mixture configured for rapid polymerization at ambient conditions to at least a portion of said cavity of said mold;
rapidly polymerizing said prepolymer mixture to form a non-porous sealant;
depositing said formable composition in said cavity of said mold over said sealant;
curing said formable composition within said cavity to form a disposable tooling core having a working surface, said sealant and said tooling core forming a tooling member, said sealant preventing resin migration into said disposable tooling core during manufacture of a composite article; and
removing said tooling member from said mold cavity, said sealant being disposed over said working surface of said tooling core.

25. The method of claim 24, wherein said prepolymer mixture is a polyurea-based resin made from mixing an isocyanate component and a resin blend component.

26. The method of claim 25, wherein said isocyanate component further comprises an isocyanate building block connected to a flexible link with a urethane bond.

27. The method of claim 26, wherein said isocyanate building block is an MDI monomer.

28. The method of claim 26, wherein said flexible link is selected from a group consisting of polyether, silicone, and polybutadiene.

29. The method of claim 25, wherein said resin blend component further comprises an amine-terminated polymer resin.

30. The method of claim 24, wherein said prepolymer mixture comprises, at least in part, a sprayable silicone.

31. A method for manufacturing a composite article from a disposable tooling member, said method comprising:
obtaining a mold having a cavity formed therein;
preparing a formable composition;
applying a liquid prepolymer mixture configured for rapid polymerization at ambient conditions to at least a portion of said cavity of said mold;
rapidly polymerizing said prepolymer mixture to form a non-porous sealant;
depositing said formable composition in said cavity of said mold over said sealant;
curing said formable composition within said cavity to form a disposable tooling core having a working surface, said sealant preventing resin migration into said disposable tooling core during manufacture of a composite article, said sealant and said tooling core forming a tooling member;
removing said tooling member from said mold cavity, said sealant being disposed over said working surface of said tooling core;
laying up a composite prepreg over said sealant and said tooling member;
forming a composite article about said tooling member from said composite prepreg;
destroying said tooling core once said composite article is formed; and
removing said sealant from said composite article once said tooling core is destroyed.

32. The method of claim 31, wherein said prepolymer mixture is a polyurea-based resin made from mixing an isocyanate component and a resin blend component.

33. The method of claim 32, wherein said isocyanate component further comprises an isocyanate building block connected to a flexible link with a urethane bond.

34. The method of claim 33, wherein said isocyanate building block is an MDI monomer.

35. The method of claim 33, wherein said flexible link is selected from a group consisting of polyether, silicone, and polybutadiene.

36. The method of claim 32, wherein said resin blend component further comprises an amine-terminated polymer resin.

37. The method of claim 31, wherein said prepolymer mixture comprises, at least in part, a sprayable silicone.

38. A method for manufacturing a disposable tooling member for use in a bladder molding process for the fabrication of composite articles, said method comprising:
obtaining a mold having an inner working surface formed thereon;
obtaining a spacer conforming to and providing a scaled inner surface corresponding to said inner working surface of said mold;
applying a liquid prepolymer mixture configured for rapid polymerization at ambient conditions to at least a portion of said scaled inner surface of said spacer;
rapidly polymerizing said prepolymer mixture to form a sealant configured to function as a bladder;
preparing a formable composition;
depositing said formable composition on an inner surface of said bladder; and
curing said formable composition to form a disposable core, said disposable core and said bladder making up said disposable tooling member.

39. The method of claim 38, further comprising:
depositing a polystyrene foam composition over said formable composition; and
inserting an axle within said polystyrene foam composition, said polystyrene foam composition and said axle also being part of said disposable tooling member.

40. The method of claim 38, wherein said formable composition comprises a urethane foam.

41. The method of claim 38, wherein said prepolymer mixture is a polyurea-based resin made from mixing an isocyanate component and a resin blend component.

42. The method of claim 41, wherein said isocyanate component further comprises an isocyanate building block connected to a flexible link with a urethane bond.

43. The method of claim 42, wherein said isocyanate building block is an MDI monomer.

44. The method of claim 42, wherein said flexible link is selected from a group consisting of polyether, silicone, and polybutadiene.

45. The method of claim 41, wherein said resin blend component further comprises an amine-terminated polymer resin.

46. The method of claim 38, wherein said prepolymer mixture comprises, at least in part, a sprayable silicone.

47. A method for manufacturing a composite article in accordance with the steps of claim 38, further comprising:
separating said tooling member from said spacer to expose an outer surface of said bladder;
laying up a composite prepreg about said tooling member and over said outer surface of said bladder;
inserting said tooling member, with said composite lay-up, into said mold; and
forming said composite part by pressurizing said bladder to force said composite prepreg against said inner working surface of said mold.

48. The method of claim 47, further comprising:
disposing of said tooling member once said composite article is formed by destroying said core, and removing said bladder from said composite article.

49. The method of claim 47, wherein said prepolymer mixture is a polyurea-based resin made from mixing an isocyanate component and a resin blend component.

50. The method of claim 49, wherein said isocyanate component further comprises an isocyanate building block connected to a flexible link with a urethane bond.

51. The method of claim 50, wherein said isocyanate building block is an MDI monomer.

52. The method of claim 50, wherein said flexible link is selected from a group consisting of polyether, silicone, and polybutadiene.

53. The method of claim 49, wherein said resin blend component further comprises an amine-terminated polymer resin.

54. The method of claim 47, wherein said prepolymer mixture comprises, at least in part, a sprayable silicone.

55. A tooling member for use in the fabrication of composite articles, said tooling member comprising:
a formed, disposable tooling core made from a formable composition; and
a pliable sealant adjacent said formed, disposable tooling core,
said sealant being formed from a liquid prepolymer mixture configured for rapid polymerization at ambient conditions to prevent resin migration into said disposable tooling core during manufacture of a composite article.

56. The tooling member of claim 55, wherein said formed, disposable core comprises a pre-formed core having an outer working surface, wherein said sealant is positioned about said outer working surface of said pre-formed core.

57. The tooling member of claim 55, wherein said formed, disposable core comprises a post-formed core resulting from application of said disposable composition to an inner surface of said sealant, as pre-formed, said sealant providing a bladder function within a bladder molding process.
